(19) United States
(12) Patent Application Publication
(10) Pub. No.: US 2025/0362962 A1
(43) Pub. Date: Nov. 27, 2025

(54) DIGITAL SERVICE BASED FLOW CONTROL SERVER, METHOD AND API FLOW CONTROL SYSTEM

(71) Applicant: STCLAB. CO., LTD., Seoul (KR)

(72) Inventors: Changho HWANG, Yongin-si (KR); Hyung Joon PARK, Seoul (KR)

(73) Assignee: STCLAB. CO., LTD., Seoul (KR)

(21) Appl. No.: 19/254,957

(22) Filed: Jun. 30, 2025

Related U.S. Application Data
(63) Continuation of application No. PCT/KR2023/021770, filed on Dec. 27, 2023.

(30) Foreign Application Priority Data
Dec. 30, 2022 (KR) 10-2022-0190175

(51) Int. Cl. G06F 9/50

(52) U.S. Cl. CPC G06F 9/5027

(57) ABSTRACT

The present disclosure relates to a digital service-based flow control server, method, and system for assigning response priorities to API (application programming interface) call subjects and efficiently managing API flow.

### CROSS-REFERENCE TO RELATED APPLICATIONS

The present application is a Continuation of International Application No. PCT/KR2023/021770 filed on Dec. 27, 2023, which is based upon and claims the benefit of priority to Korean Patent Application No. 10-2022-0190175 filed on Dec. 30, 2022 in the Korean Intellectual Property Office, the entire contents of which are incorporated herein by reference.

### TECHNICAL FIELD

The present disclosure relates to a method for controlling a flow rate in response to an API request. More specifically, the present disclosure relates to a digital service-based flow rate control server, method, and system.

### BACKGROUND ART

As the number of simultaneous users of a service server providing content services such as course registration, concert reservation, and purchase events increases, the response speed of the service server providing the content services is often reduced or the service is interrupted.

The system may include a WEB providing a page composed of HTML (hypertext markup language), a WAS (web application server) processing an application service for a request message transmitted from the WEB, and a database storing data that can be provided as a response to a query statement.

The above-described system may be linked to a plurality of servers that relays the content services provided by the system, including an API (application programming interface).

Meanwhile, request signals related to the content services may occur simultaneously from the plurality of servers, and if the responses to these signals are not processed smoothly, dissatisfaction of the end user may occur.

### DETAILED DESCRIPTION OF THE INVENTION

### Technical Problem

The embodiment disclosed in the present disclosure is to provide a digital service-based flow control server, method and system for efficiently managing API flow by assigning response priorities to API (application programming interface) call subjects.

The problems to be solved by the present disclosure are not limited to the problems mentioned above, and other problems not mentioned will be clearly understood by those skilled in the art from the description below.

### Technical Solution

In an aspect of the present disclosure, a digital service-based flow control server may include a communication module; and a processor connected to the communication module and configured to control an application programming interface (API) flow, wherein the processor is configured to: linked to a service server providing a specific content service, receive a request signal from a plurality of API request servers relaying the specific content service, determine a priority of the plurality of API request servers that is going to transmit a response signal to the request signal, and change a first priority determined based on the request signal for each of the plurality of API request servers to a second priority based on a status of the service server, transmit the request signal of the plurality of API request servers to the service server according to the second priority, and determine the first priority based on a call identifier included in the request signal and a frequency of the request signal, and determine the request signal of the API request server corresponding to a self-application providing the specific content service through a self-API of the service server among the plurality of API request servers as a highest priority based on the call identifier, and determine a remaining API request servers as a high priority in an order of frequency.

Furthermore, in another aspect of the present disclosure, a digital service-based flow control system may include a service server configured to provide a specific content service; a plurality of application programming interface (API) request servers configured to generate a request signal related to the specific content service; and a flow control server configured to receive the request signal from the plurality of API request servers and determine the priority of the plurality of API request servers that is going to transmit a response signal to the request signal, and change a first priority determined based on the request signal for each of the plurality of API request servers to a second priority based on a status of the service server, wherein the flow control server is configured to: determine the first priority based on a call identifier included in the request signal and a frequency of the request signal, and determine the request signal of the API request server corresponding to a self-application providing the specific content service through a self-API of the service server among the plurality of API request servers as a highest priority based on the call identifier, and determine a remaining API request servers as a high priority in an order of frequency.

Furthermore, in another aspect of the present disclosure, a digital service-based flow control method performed by a flow control server may include receiving a request signal from a plurality of application programming interface (API) request servers linked to a service server for providing a specific content service; determining priorities of the plurality of API request servers that is going to transmit a response signal to the plurality of API request servers, and changing a first priority determined based on the request signal for each of the plurality of API request servers to a second priority based on a status of the service server; and transmitting the request signal of the plurality of API request servers to the service server according to the second priority, wherein the first priority is determined based on a call identifier included in the request signal and a frequency of the request signal, and a request signal of the API request server corresponding to a self-application providing the specific content service through a self-API of the service server among the plurality of API request servers is determined as a highest priority based on the call identifier, and the remaining API request servers are determined as a higher priority in an order of frequency.

In addition, a computer program stored in a computer-readable recording medium for executing a method for implementing the present disclosure may be further provided.

In addition, a computer-readable recording medium recording a computer program for executing a method for implementing the present disclosure may be further provided.

### Advantageous Effects of the Invention

According to the present disclosure, it is expected that the API (application programming interface) call subjects can be given response priorities to efficiently manage the API flow.

In addition, according to the present disclosure, since the response to the API call is performed by considering not only the response priorities of the API call subjects but also the status of the service server, it is expected that more efficient API flow control can be performed, and thus the satisfaction of the end user using the content service can be increased.

The effects of the present disclosure are not limited to the effects mentioned above, and other effects not mentioned will be clearly understood by those skilled in the art from the description below.

### DESCRIPTION OF THE DRAWINGS

FIG. 1 is a diagram illustrating a configuration of an API flow control system of the present disclosure.

FIG. 2 is a block diagram illustrating a configuration of a flow control server of the present disclosure.

FIGS. 3 to 9 are exemplary diagrams for describing an API flow control method of the present disclosure.

FIG. 10 is a flow chart for describing a flow control method of the present disclosure.

### BEST MODE

In the drawings, the same reference numeral refers to the same element. This disclosure does not describe all elements of embodiments, and general contents in the technical field to which the present disclosure belongs or repeated contents of the embodiments will be omitted. The terms, such as “unit, module, member, and block” may be embodied as hardware or software, and a plurality of “units, modules, members, and blocks” may be implemented as one element, or a unit, a module, a member, or a block may include a plurality of elements.

Throughout this specification, when a part is referred to as being “connected” to another part, this includes “direct connection” and “indirect connection”, and the indirect connection may include connection via a wireless communication network. Furthermore, when a certain part “includes” a certain element, other elements are not excluded unless explicitly described otherwise, and other elements may in fact be included.

Furthermore, when a certain part “includes” a certain element, other elements are not excluded unless explicitly described otherwise, and other elements may in fact be included.

In the entire specification of the present disclosure, when any member is located “on” another member, this includes a case in which still another member is present between both members as well as a case in which one member is in contact with another member.

The terms “first,” “second,” and the like are just to distinguish an element from any other element, and elements are not limited by the terms.

The singular form of the elements may be understood into the plural form unless otherwise specifically stated in the context.

Identification codes in each operation are used not for describing the order of the operations but for convenience of description, and the operations may be implemented differently from the order described unless there is a specific order explicitly described in the context.

Hereinafter, operation principles and embodiments of the present disclosure will be described with reference to the accompanying drawings.

In this specification, the ‘API flow control server according to the present disclosure’ includes various devices that may perform computational processing and provide results to a user. For example, the API flow control server according to the present disclosure may include a computer, a server device, and a portable terminal, or may be in the form of any one of them.

Here, the computer may include, for example, a notebook, a desktop, a laptop, a tablet PC, a slate PC, and the like equipped with a web browser.

The server device is a server that communicates with an external device to process information, and may include an application server, a computing server, a database server, a file server, a game server, a mail server, a proxy server, and a web server.

The portable terminal may include, for example, a wireless communication device that ensures portability and mobility, such as a PCS (Personal Communication System), a GSM (Global System for Mobile communications), a PDC (Personal Digital Cellular), a PHS (Personal Handyphone System), a PDA (Personal Digital Assistant), an IMT (International Mobile Telecommunication)-2000, a CDMA (Code Division Multiple Access)-2000, a W-CDMA (W-Code Division Multiple Access), a WiBro (Wireless Broadband Internet) terminal, a smart phone, and all kinds of handheld-based wireless communication devices, as well as wearable devices such as watches, rings, bracelets, anklets, necklaces, glasses, contact lenses, or head-mounted devices (HMDs).

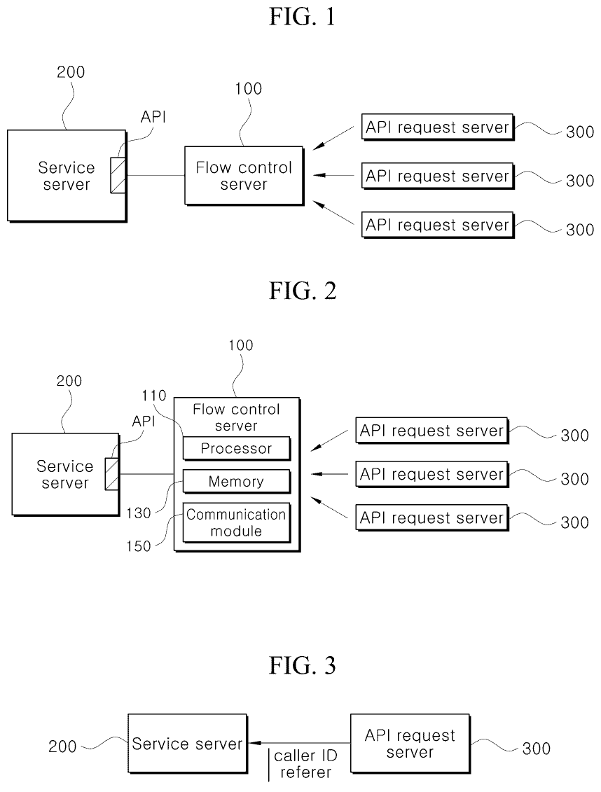

FIG. 1 is a diagram illustrating a configuration of an API flow control system of the present disclosure.

Referring to FIG. 1, an API flow control system may include a flow control server 100, a service server 200, and an API request server 300. As shown, there may be a plurality of API request servers 300.

The service server 200 may be a component for providing a specific content service.

For example, the service server 200 may be a component (e.g., a server of Booking.com) for providing a content service for reserving accommodations including hotels related to travel. This content service may be provided through a web page (e.g., the Booking.com home page) or an application through an API provided by the service server 200 itself, but may also be provided through relaying on various portal servers such as NAVER and DAUM.

Specifically, the service server 200 is a server that provides a content service including an application programming interface (API), and the API may be called from a plurality of API request servers 300. At this time, the API request may be various requests related to the content service for example, requests for accommodation details, reservation information, and the like.

As an example, the same API may provide the same data regardless of the calling subject API request server 300. As another example, some APIs may provide different data according to search conditions included in the request signals of each of the plurality of API request servers 300. In the process where the API of one service server 200 is called from plurality of API request servers 300 that are multiple partners, a response priority from a business perspective may occur. For example, in the case that there is a need to quickly respond to an API request (request signal) from partner A with the highest priority, it may be processed with a priority and the API request from partner B may be processed with a relatively lower priority.

In the case that a WAS (web application server) performs the role of the service server (API server) 200, the response speed of the company's service may be adjusted depending on whether the API is called from within the service server 200 or from the outside. That is, each of the above-described plurality of API request servers 300 generates an API request as an API, but may perform a response relatively quickly or slowly according to a preset setting for the API request generated from within the service server 200 among the plurality of API request servers 300.

The above-described WAS refers to an application server using HTTP, and may include a container that enables dynamic data to be used in a web server specialized in static HTTP data processing.

The WAS may be an application server for providing dynamic content that requires database query or various logic processing. The WAS may be a middleware (software engine) that executes an application on a computer or device via HTTP. The WAS may also be called a web container or a servlet container. In this case, the container may mean software that may execute JSP and Servlet. The WAS may be applied in a distributed environment that handles functions such as distributed transactions, security, messaging, and thread processing. Specifically, the WAS may implement a program execution environment, a database connection function, and many transaction management functions. The transaction may mean a logical work module. The WAS may receive the corresponding data from the database according to the user's request, and generate and provide the result in real time according to the business logic.

Meanwhile, the service server 200 may include a web server, the web application server (hereinafter referred to as the WAS), and a database (DB). In this case, the database may also be called a database management system (DBMS).

The web server refers to a server that mainly processes requests from clients such as a web browser or a web crawler based on the HTTP (hypertext transfer protocol), and may reply with an HTTP response when receiving an HTTP request.

For example, the web server may receive a file path name and return static file content (html, jpeg, css, etc.) that matches the path.

The web server may transmit a request for providing dynamic content to the WAS, and receive the processing result from the WAS and transmit the result to a client.

The plurality of API request servers 300 may be linked to the service server 200 and generate a request signal related to a specific content service. For example, the plurality of API request servers 300 of the present disclosure may refer to a relay server such as various portal servers such as NAVER, DAUM, and the like described above.

The flow control server 100 may be positioned to manage a request signal (API call or API request) in front of the service server 200 (e.g., a service server that is an API server or a WAS server) in the communication flow. To this end, the flow control server 100 may receive a request signal (API request) generated from the plurality of API request servers 300.

The flow control server 100 may receive a request signal generated from the plurality of API request servers 300, and may determine a priority of the plurality of API request servers 300 that is going to transmit a response signal for the request signal based on a status of the service server 200 and the request signal. In other words, the priority of transmitting a response to the request signal to which of the plurality of API request servers 300 is to be determined.

To this end, the flow control server 100 may monitor the resource status of the service server 200. The priority may be set directly by an operator, and the priority may be given to each of the plurality of API request servers 300 which is call identifiers.

When the flow control server 100 confirms an API request with a relatively high priority, the flow control server 100 may change a waiting order in the queue for connection with the service server 200 so that the API request may be quickly delivered to the service server 200.

Due to the API flow control in the present disclosure, it is expected that the priority adjustment may be available in an environment where all subjects call the same API function without the need to separately implement a VIP service server.

Meanwhile, for the API flow control of the present disclosure, the service server 200 may be automatically driven by installing an agent (e.g., an agent for the WAS) without modifying the existing code. At this time, the agent for API flow control may also be installed in each of the plurality of API request servers 300. In this case, the agent may be delivered to the service server 200 and the plurality of API request servers 300 in the form of a software development kit (SDK).

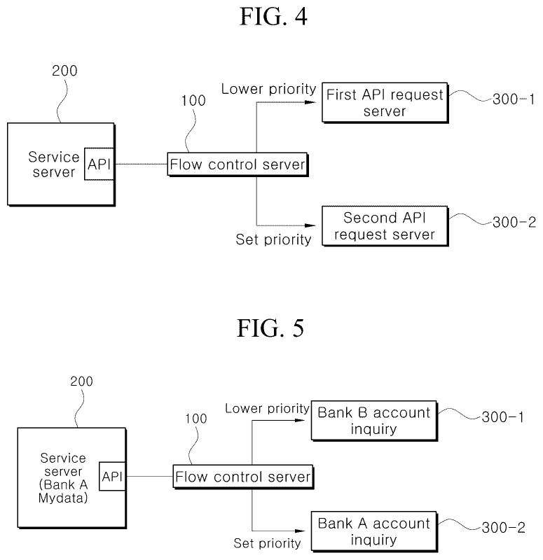

FIG. 2 is a block diagram illustrating a configuration of a flow control server of the present disclosure.

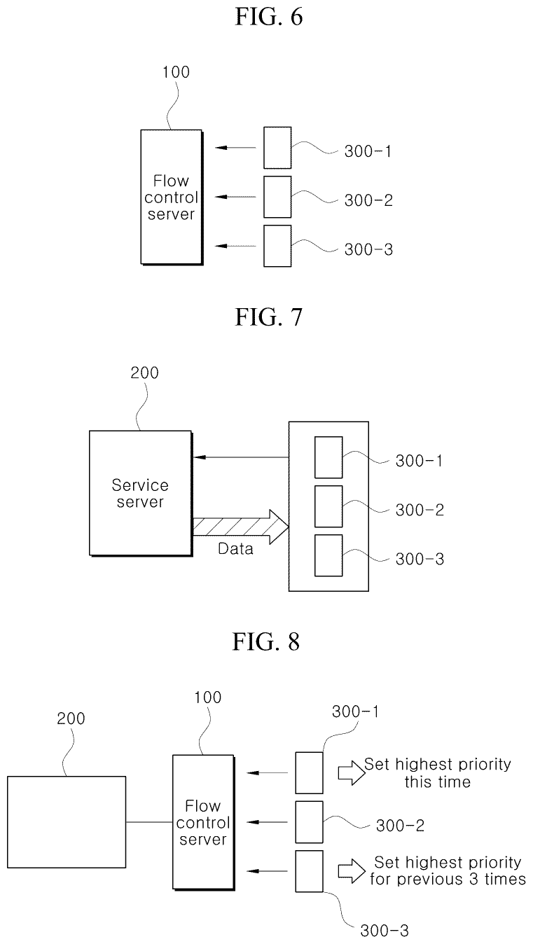

Hereinafter, the API flow control method of the present disclosure will be described with reference to FIGS. 3 to 9, which are exemplary diagrams for describing the method.

Referring to FIG. 2, the flow control server 100 includes a processor 110, a memory 130, and a communication module 150. The components illustrated in FIG. 2 are not essential for implementing the flow control server 100 according to the present disclosure, and thus, the flow control server 100 described in this specification may have more or fewer components than the components listed above.

The processor 110 may be connected to the communication module 150 and configured to control the API (application programming interface) flow rate.

The processor 110 may be connected to the service server 200 that provides a specific content service and may receive a request signal generated from the plurality of API request servers 300 that relay the specific content service. In this case, the request signal is an API request and may include various information related to the specific content service, including a call identifier and reference information.

The processor 110 may determine the priority of the plurality of API request servers 300 that is going to transmit a response signal to the request signal based on the status of the service server 200 and the request signal.

As an example, when determining the priority, the processor 110 may determine the priority based on the call identifier and the reference information included in the request signal of the plurality of API request servers 300. At this time, the criterion for determining the priority based on the call identifier and the reference information may be preset arbitrarily by the operator. That is, the criterion for determining the priority may include the criterion for setting the API request server 300 to be assigned the highest priority in advance, or the criterion for setting the priority of each of the plurality of API request servers 300.

Referring to FIG. 3, the plurality of API request servers 300 may transmit a request signal including the call identifier such as a caller ID and the reference information such as a referer to the flow control server 100. The reference information may include an absolute or partial address of the page that currently sent the request. In the case that the reference information is a link, the reference information may include the address of the page including the link.

For example, the processor 110 may determine the priority based on the call identifier and the reference information, and determine the priority of the API request server 300 corresponding to a self-application of the service server 200 set as the highest priority. Alternatively, the processor 110 may set the priority of the API request server 300 that is agreed to provide a response to the API call (request signal) as the highest priority. That is, the processor 110 may determine the response priority of the API request server 300 according to the priority set by the operator. At this time, the operator may also set the priority by prior agreement with the service server 200.

Meanwhile, an OTA (online travel agency) online travel platform is a platform that provides a reservation agency service for each accommodation facility online, and may be connected to API request servers 300 that provide a metasearch service through an API. In the present disclosure, the OTA online travel platform may mean the service server 200. That is, each of the service server 200 and the API request server 300 may be connected to each other via an API.

For example, referring to FIG. 4, a first API request server 300-1 and a second API request server 300-2 may request accommodation information to the service server 200 according to the request of an end user, and the service server 200 may request and receive the accommodation information from the hotel and reply. In this case, the end user may access the API request server 300 through a user terminal 100 including a mobile terminal such as a mobile phone or a wired terminal such as a desktop. The first API request server 300-1 is a server that provides metasearch services such as Kayak and Skyscanner, the second API request server 300-2 is a self-operating server of the service server 200, and the service server 200 may mean an API server such as Booking.com.

The processor 110 of the flow control server 100 may set the response priority for the request signal (API request) generated from the second API request server 300-2 operated by the service server 200 according to a preset to a relatively higher priority, and may set the priority of the first API request server 300-1 providing the meta search service to a lower priority. In other words, the response priority of the second API request server 300-2 may be set to the first priority, and the response priority of the first API request server 300-1 may be set to the second priority.

The processor 110 may also change the method of determining the priority of the API request server 300 operated by the service server 200 to a relatively higher priority to a method of determining the priority to a lower priority according to business needs. In other words, it may also be possible to apply the above-described method in reverse.

On the other hand, the system for MyData in the financial sector has been improved, and an open banking system is being provided that allows users to inquire about other bank accounts in their name from a single bank service server. Referring to FIG. 5, the processor 110 may set different priorities for the account inquiry API called from the second API request server 300-2 of Bank A, which is directly linked to the service server 200 providing the Bank A service, and the account inquiry API called from the first API request server 300-1 of Bank B. For example, as shown in FIG. 9, the processor 110 may set the priority of the second API request server 300-2 of Bank A to the highest priority and the priority of the first API request server 300-1 of Bank B to the lower priority. In this way, it is expected that efficient server operation may be achieved by controlling responses to API calls.

As another example, when determining the priority, the processor 110 may determine the priority based on the frequency of the request signals transmitted from the plurality of API request servers 300, and determine the priority as a higher priority as the higher the frequency of the request signals.

Referring to FIG. 6, the processor 110 may determine the higher priority as the frequency of the request signals transmitted from the plurality of API request servers 300. That is, the priority of the plurality of API request servers 300 may be set to the server with the highest frequency of the request signals (N1>N2) as the highest priority, and the priorities may be sequentially set (P1>P2) according to the frequency. The N may represent the frequency of the request signals, and P may represent the priority.

As another example, referring to FIG. 7, when determining the priority, the processor 110 determines the priority based on a size of data to be returned to plurality of API request servers 300 in response to the request signal, and may determine a higher priority as the size of the data to be returned is greater. For example, in the case that the sizes of data to be returned in response to the request signals generated from the first and second API request servers 300-2 are D1>D2, the processor 110 may determine the priority (P1>P2) so that the response to the request signal of the first API request server 300-1 with a greater data size may be processed with priority over the response to the request signal of the second API request server 300-2. For example, the data to be returned in response to the request signal may include various information related to the content service, such as an accommodation image and an accommodation introduction.

As another example, when determining the priority, the processor 110 may set a preset higher priority to each of the plurality of API request servers 300 at a preset interval based on the accumulated priorities of the plurality of API request servers 300. That is, when the accumulated priority is low, the processor 110 may evenly distribute a higher priority (e.g., the highest priority or a higher priority higher than the preset priority) to the plurality of API request servers 300.

Referring to FIG. 8, when a third API request server 300-3 among the plurality of API request servers 300 is set as the highest priority for the previous three times, the processor 110 may set the first API request server 300-1 as the highest priority this time. That is, the processor 110 may set the highest priority to the API request server 300 that is responded to the request signal relatively late every time, at preset intervals, so that the API request server 300 may receive a response quickly.

The method for determining the priority described above may be applied alone or in combination of at least one method.

Specifically, when determining the priority, the processor 110 may determine the highest priority based on the call identifier and the reference information included in the request signals of the plurality of API request servers 300, and may determine the lower priority based on the frequency of the request signals transmitted from the remaining plurality of API request servers 300. For example, among the first API request server 300 to the fourth API request server 300, the first API request server 300 agreed upon in advance may be given the first priority, and the second to fourth API request servers 300 may be given the second, third, and fourth priorities, respectively, based on the frequency of the request signals.

In addition, the processor 110 may set the priority based on at least one of the following: the call identifier and the reference information included in the request signals of the plurality of API request servers 300, the frequency of the request signals transmitted from the plurality of API request servers 300, the size of data to be returned to the plurality of API request servers 300, and the accumulated priority of the plurality of API request servers 300, and set a preset higher priority to each of the plurality of API request servers 300 at a preset interval, and a combination thereof.

After the priority of a specific API request server 300 among the plurality of API request servers 300 is determined to be the highest priority, the processor 110 may transmit a delay notification to the API request server 300 when the resources of data to be returned in response to the request signal of the corresponding API request server 300 are insufficient. That is, when the service server 200 lacks resources to process the response data for the request signal of the API request server 300 determined as the highest priority, this situation is transmitted to the API request server 300 through a delay notification. As a result, it is expected that the complaints of the end user who is using the content service through the API request server 300 regarding the response delay may be resolved in advance.

The processor 110 may change the first priority determined for each of the plurality of API request servers to the second priority based on the status of the service server 200, but may change the priority based on at least one of CPU status or GPU status of the service server 200. At this time, the status of the service server is not limited to the CPU status and the GPU status, and may include the status of all configurations within the service server 300 that needs to be considered in generating and responding the response data for the request signal (API request) in relation to the content service.

That is, the processor 110 may control in different ways depending on the type of the received request signal API request. The processor 110 may arbitrarily adjust the priority when a specific request signal excessively uses resources of a specific internal configuration in the service server 200 or causes a load on a specific table of the DB. To this end, the processor 110 may additionally construct and manage information on DB tables or service server resources referenced by each API function.

Referring to FIG. 9, the processor 110 may assign priority 1, which is the highest priority, to the first API request server 300-1, priority 2 to the second API request server 300-2, and priority 3 to the third API request server 300-3.

In this case, the response data corresponding to the request signal of the first API request server 300-1 may be processed by the CPU in the service server 200, and the response data corresponding to the request signal of the second API request server 300-2 may be processed by the GPU in the service server 200.

The processor 110 may request and receive the status of the service server 200 including the CPU status and the GPU status, and as a result of analyzing the status, the processor may identify that the CPU status is in a status where the response data corresponding to the request signal may not be immediately processed due to insufficient resources, and the like, and that the GPU status is good. The processor 110 may change the priority of the first API request server 300-1 from priority 1 to priority 2, and may change the priority of the second API request server 300-2 from priority 2 to priority 1, according to the analysis result described above.

Meanwhile, changing the priority based on the status of the service server 200 including the CPU status and the GPU status of the processor 110 described above may also be implemented by the service server 200. That is, the service server 200 may change the processing order of the request signals transmitted from the plurality of API request servers 300 transmitted from the processor 110 based on the status of the service server, not the order of the request signals transmitted from the API request servers 300, according to the priority set by the processor 110.

The processor 110 may transmit the request signals of the plurality of API request servers 300 to the service server 200 according to the priority.

Meanwhile, the processor 110 may delay the transmission by generating a queue without transmitting the request signal (API request) to the service server 200 according to the status of the service server 200 separately from the priority.

On the other hand, the service server 200 may sequentially respond to the request received from the flow control server 100, but may internally change the priority and process the request by considering the standby status between the server and the DB, such as the Surf DB.

The memory 130 may store a computer program for providing the API flow control method, and the stored computer program may be read and operated by the processor 110. The memory 130 may store any form of information generated or determined by the processor 110 and any form of information received by the communication module 150.

The memory 130 may store data supporting various functions of the flow control server 100, a program for the operation of the processor 110, may store input/output data, and may store a plurality of application programs (or applications) operated by the flow control server 100, data for the operation of the flow control server 100, and commands. At least some of these application programs may be downloaded from an external server via wireless communication.

The memory 130 may include at least one type of storage medium among a flash memory type, a hard disk type, an SSD (Solid State Disk) type, an SDD (Silicon Disk Drive) type, a multimedia card micro type, a card type memory (e.g., an SD or XD memory, etc.), random access memory (RAM), static random access memory (SRAM), read-only memory (ROM), electrically erasable programmable read-only memory (EEPROM), programmable read-only memory (PROM), a magnetic memory, a magnetic disk, and an optical disk. In addition, the memory may be a database that is separate from the device but connected by wire or wirelessly.

The communication module 150 may include one or more components that enable communication with an external device, and may include, for example, at least one of a broadcast receiving module, a wired communication module, a wireless communication module, a short-range communication module, and a location information module.

Although not illustrated, the flow control server 100 of the present disclosure may further include an output module and an input module.

The output module may display a user interface (UI) for providing API flow control results, and the like The output module may output any form of information generated or determined by the processor 110 and any form of information received by the communication module 150.

The output module may include at least one of a liquid crystal display (LCD), a thin film transistor-liquid crystal display (TFT LCD), an organic light-emitting diode (OLED), a flexible display, and a three-dimensional display (3D display). Some of these display modules may be configured as transparent or light-transmitting so that the outside may be seen through them. This may be referred to as a transparent display module, and a representative example of the transparent display module is TOLED (Transparent OLED).

The input module may receive information input by a user. The input module may have keys and/or buttons on a user interface for receiving information input by a user, or physical keys and/or buttons. A computer program for controlling a display according to embodiments of the present disclosure may be executed according to user input through the input module.

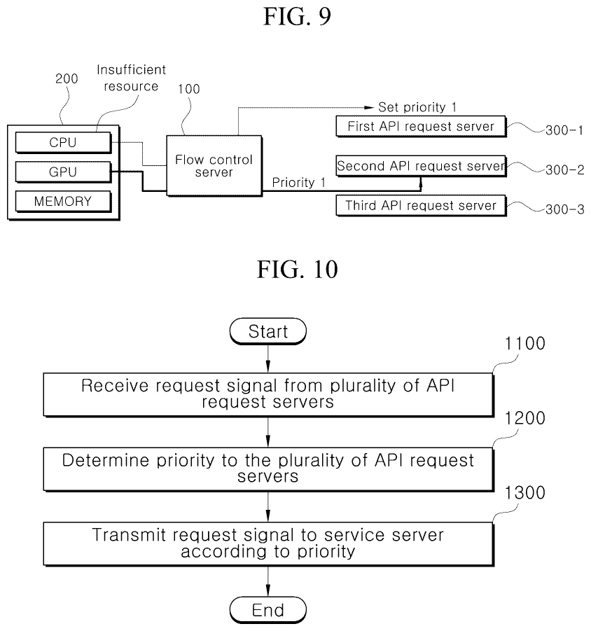

FIG. 10 is a flow chart for describing a flow control method of the present disclosure.

The flow control method disclosed in FIG. 10 may apply all technologies implemented through the flow control server 100 of FIG. 2 described above, and for the convenience of description, redundant detailed descriptions will be omitted.

The processor 110 of the flow control server 100 may receive a request signal generated from the plurality of API request servers linked to the service server for providing specific content (step 1100).

Next, the processor 110 may determine a priority for transmitting a response signal to the plurality of API request servers 300 based on the status of the service server 200 and the request signal (step 1200). That is, the priority may mean a response priority.

As an example, when determining the priority, the processor 110 may determine the priority based on the call identifier and the reference information included in the request signal of the plurality of API request servers 300.

As another example, when determining the priority, the processor 110 may determine the priority based on the frequency of the request signal transmitted from the plurality of API request servers 300, and determine the priority as a higher priority as the frequency of the request signal increases.

As another example, when determining the priority, the processor 110 may determine the priority based on the size of data to be returned to the plurality of API request servers 300 in response to the request signal, and may determine a higher priority as the size of the data to be returned is greater. As another example, when determining the priority, the processor 110 may set a preset higher priority to each of the plurality of API request servers 300 at a preset interval based on the accumulated priorities of the plurality of API request servers 300.

Next, the processor 110 may transmit the request signals of the plurality of API request servers 300 to the service server 200 according to the priorities (step 1300).

All online-based service providers (the service server 200 of the present disclosure) may provide APIs for various reasons. The API may be utilized as a means for a service provider to transmit necessary data to another external company (e.g., the API request server 300 of the present disclosure). Independent business providers centered on APIs (such as Linkhub, which only provides APIs) are also emerging, and since APIs serve as a focal point for partnerships, Google, Facebook, Kakao, and the like all generate and provide APIs. Since the present disclosure systematically controls the flow of such APIs, it is expected that a smooth API service (content service) may be provided.

Meanwhile, the method according to the present disclosure described above may be implemented as a program (or application) and stored in a medium to be executed in combination with a hardware server.

The disclosed embodiments may be implemented in the form of a recording medium that stores instructions executable by a computer. The instructions may be stored in the form of program codes, and when executed by a processor, may create a program module to perform the operations of the disclosed embodiments. The recording medium may be implemented as a recording medium that may be read by a computer.

A computer-readable recording medium includes all types of recording media that store instructions that may be decoded by a computer. For example, there may be ROM (Read Only Memory), RAM (Random Access Memory), a magnetic tape, a magnetic disk, a flash memory, an optical data storage device, and the like.

The disclosed embodiments have been described with reference to the attached drawings as described above. Those skilled in the art to which the present disclosure pertains will understand that the present disclosure may be implemented in forms other than the disclosed embodiments without changing the technical idea or essential features of the present disclosure. The disclosed embodiments are exemplary and should not be construed as limiting.

1. A digital service-based flow control server, comprising:
a communication module; and
a processor connected to the communication module and configured to control an application programming interface (API) flow,
wherein the processor is configured to:
linked to a service server providing a specific content service, receive a request signal from a plurality of API request servers relaying the specific content service,
determine a priority of the plurality of API request servers that is going to transmit a response signal to the request signal, and change a first priority determined based on the request signal for each of the plurality of API request servers to a second priority based on a status of the service server,
transmit the request signal of the plurality of API request servers to the service server according to the second priority, and
determine the first priority based on a call identifier included in the request signal and a frequency of the request signal, and determine the request signal of the API request server corresponding to a self-application providing the specific content service through a self-API of the service server among the plurality of API request servers as a highest priority based on the call identifier, and determine a remaining API request servers as a high priority in an order of frequency.

2. The server according to claim 1, wherein the processor is configured to determine the first priority by considering a size of data to be returned to the plurality of API request servers in response to the request signal instead of the frequency, and determine a higher priority as the size of the data to be returned is greater.

3. The server according to claim 1, wherein the processor is configured to determine the first priority by considering a cumulative priority of the plurality of API request servers instead of the frequency, and determine a higher priority as the cumulative priority is lower.

4. The server according to claim 1, wherein the processor is configured to:
based on the resources for data that needs to be responded to in response to the request signal from the specific API request server being insufficient after the priority of a specific API request server among the plurality of API request servers is determined to be the highest priority, transmit a delay notification to the specific API request server.

5. The server according to claim 1, wherein the status of the service server includes at least one of a CPU status or a GPU status.

6. A digital service-based flow control system, comprising:
a service server configured to provide a specific content service;
a plurality of application programming interface (API) request servers configured to generate a request signal related to the specific content service; and
a flow control server configured to receive the request signal from the plurality of API request servers and determine the priority of the plurality of API request servers that is going to transmit a response signal to the request signal, and change a first priority determined based on the request signal for each of the plurality of API request servers to a second priority based on a status of the service server,
wherein the flow control server is configured to:
determine the first priority based on a call identifier included in the request signal and a frequency of the request signal, and determine the request signal of the API request server corresponding to a self-application providing the specific content service through a self-API of the service server among the plurality of API request servers as a highest priority based on the call identifier, and determine a remaining API request servers as a high priority in an order of frequency.

7. The system according to claim 6, wherein the flow control server is configured to determine the first priority by considering a size of data to be returned to the plurality of API request servers in response to the request signal instead of the frequency, and determine a higher priority as the size of the data to be returned is greater.

8. The system according to claim 6, wherein the flow control server is configured to determine the first priority by considering a cumulative priority of the plurality of API request servers instead of the frequency, and determine a higher priority as the cumulative priority is lower.

9. The system according to claim 6, wherein the flow control server is configured to:
based on the resources for data that needs to be responded to in response to the request signal from the specific API request server being insufficient after the priority of a specific API request server among the plurality of API request servers is determined to be the highest priority, transmit a delay notification to the specific API request server.

10. The system according to claim 6, wherein the status of the service server includes at least one of a CPU status or a GPU status.

11. A digital service-based flow control method performed by a flow control server, comprising:
receiving a request signal from a plurality of application programming interface (API) request servers linked to a service server for providing a specific content service;
determining priorities of the plurality of API request servers that is going to transmit a response signal to the plurality of API request servers, and changing a first priority determined based on the request signal for each of the plurality of API request servers to a second priority based on a status of the service server; and
transmitting the request signal of the plurality of API request servers to the service server according to the second priority,
wherein the first priority is determined based on a call identifier included in the request signal and a frequency of the request signal, and a request signal of the API request server corresponding to a self-application providing the specific content service through a self-API of the service server among the plurality of API request servers is determined as a highest priority based on the call identifier, and the remaining API request servers are determined as a higher priority in an order of frequency.

12. The method according to claim 11, wherein the flow control server is configured to determine the first priority by considering a size of data to be returned to the plurality of API request servers in response to the request signal instead of the frequency, and determine a higher priority as the size of the data to be returned is greater.

13. The method according to claim 11, wherein the flow control server is configured to determine the first priority by considering a cumulative priority of the plurality of API request servers instead of the frequency, and determine a higher priority as the cumulative priority is lower.

14. The method according to claim 11, wherein the flow control server is configured to:
based on the resources for data that needs to be responded to in response to the request signal from the specific API request server being insufficient after the priority of a specific API request server among the plurality of API request servers is determined to be the highest priority, transmit a delay notification to the specific API request server.

15. The method according to claim 11, wherein the status of the service server includes at least one of a CPU status or a GPU status.
